(19) United States
(12) Patent Application Publication
(10) Pub. No.: US 2006/0072303 A1
(43) Pub. Date: Apr. 6, 2006

(54) Marine warning sign

(76) Inventors: Thomas K. Dunkle, Kenova, WV (US); Gregory D. Dunkle, Wayne, WV (US)

Correspondence Address: BOWLES RICE MCDAVID GRAFF & LOVE LLP, POST OFFICE BOX 1386, CHARLESTON, WV, 25325-1386, US

(21) Appl. No.: 10/959,524

(22) Filed: Oct. 6, 2004

(51) Int. Cl. F21V 9/16

(52) U.S. Cl. 362/84; 362/240; 362/394; 362/812; 362/802

(57) ABSTRACT

A marine warning sign, in the shape of a right prism, having a frame forming a square of other polygonal shaped enclosure with straight sides and open front and rear faces. In the front face is positioned an assembly comprised of a transparent panel under which is a graphics panel. On the obverse face of the graphics panel is printed some desired warning indicia. A rear panel enclosed the rear face of the frame. A border, in the same shape as the frame, surrounds the indicia. The border is formed of electroluminescent tape. The electroluminescent tape illuminates when energized by an electrical power control located within the sign. The electrical power control is powered by a rechargeable battery which powers an a/c to d/c inverter. The electrical power control is switched on and off during night and day, respectively, by a circuit in the electrical power control comprised of a comparator having a bridge circuit with a photoresistor as one input. Mercury level switches also are provided to disable the electrical power control if the sign is tilted from its desired level attitude. The inverter provides alternating current to two leads of the electroluminescent tape, causing the electroluminescent tape to illuminate.

### BACKGROUND OF THE INVENTION

1. Field of the Invention

The invention disclosed herein relates to a warning sign suitable for marine use

2. Description of the Prior Art

In the maritime industry, particularly on the inland and intra-coastal waterways, vessels may be forced to temporarily anchor within the waterway for emergency repairs. These vessels can potentially pose a hazard to other vessels on the waterway if the vessels under repair are not readily visible to other craft or vessels. Graphical means for alerting other craft of an anchored or disabled vessel are desirous, which can provide warning under all conditions of daylight or night, which has its own power supply and which are portable and easily erected and stowed, and which are safe under potentially rough sea conditions.

U.S. Pat. No. 6,247,700, issued to Procupetz on Jun. 19, 2001, discloses a light emitting shooting target using electroluminescent paint for greater illumination during low light environments. This may have potential application in the marine environment, but the invention, if used as a warning sign, must be switched manually and is not sufficiently rugged for the marine environment.

U.S. Pat. No. 6,263,601, issued to Emert on Jul. 24, 2001, discloses a lighted real estate sign. The sign is portable, contains its own power supply, including the use of solar power, and control circuitry for switching on the sign's illumination during low light conditions. The means for illumination includes a neon bulb, which has an overly-excessive power consumption for the desired use of a marine warning sign. Further, while it is portable, its means of securing, which includes a ground-driven stake, is unsuitable for use aboard a steel-constructed vessel.

U.S. Pat. No. 5,729,924, issued to Reading on Mar. 24, 1998, discloses an illuminated sign assembly. The sign assembly includes an electric illumination system for the sign, including a solar-powered recharging system. The illumination system, however, is based on a fluorescent lighting system, which is susceptible to damage or short circuits caused by the wet environment on a marine craft. It is also not intrinsically safe for use aboard barges containing flammable liquid cargoes. The sign assembly also does not provide a means for quickly installing or removing the sign from operation.

U.S. Pat. No. 5,533,289, issued to Hoffman on Jul. 9, 1996 for an illuminated sign, discloses a sign with stenciled indicia which are illuminated by a rear electroluminescent panel. The use of electroluminescence has advantages and potential application in the marine environment, due to its low power draw and intrinsic safety. The invention includes embodiments for D.C. battery power supplies and an inverter, necessary for electroluminescent systems which otherwise require alternating current for their operation. The patent also discloses the desirability of a flasher mechanism for controlling intermittent or flashing illumination of the electroluminescent lamp. The illuminating lamp of the sign, however, must be controlled manually. The invention also does not provide any means for rapid portability.

U.S. Pat. No. 5,005,306, issued to Kinstler on Apr. 9, 1991 for an illuminated vehicle sign, discloses a portable sign using an electroluminescent back-panel to illuminate stenciled indicia which is powered from a vehicle's cigarette lighter or other 12 volt receptacle. The invention provides the advantages of electroluminescence and portability, but lacks automatic control and an integral power supply.

U.S. Pat. No. 4,787,163, issued to Berg on Nov. 29, 1988 for a vehicle mounted sign, discloses a portable sign comprised of a triangular-shaped case and powered by the vehicle's cigarette lighter receptacle. It includes a sensing means for detecting movement, such as from a tilt in the sign, as from of an attempted theft of the sign, which then disengages power to the sign and activates an alarm. No means of automatically controlling the illumination during times of low light levels are included; the illumination is operated strictly manually.

U.S. Pat. No. 4,663,874, issued to Sano et al. on May 12, 1987, discloses a magnetically attachable sign. It can be quickly installed and removed, an advantage for marine use. However, no source of illumination for night use is provided.

### SUMMARY OF THE INVENTION

To overcome the deficiencies of the prior art, accordingly an object of the present invention is to provide an illuminated marine warning sign using an electroluminescent material.

A further object of this invention is to provide a marine warning sign with an illumination system that is automatically operated only during periods of low light illumination.

A further objective of this invention is to provide a marine warning sign with a self-contained rechargeable power supply.

A further objective of this invention is to provide a marine warning sign which is quickly installed and removed from service on a steel vessel.

A further objective of this invention to is provide a marine warning sign sufficiently rugged to operate in a marine environment, including one with exposures to hazardous cargos.

To accomplish these objectives, a marine warning sign is provided which is comprised, in the preferred embodiment, of a sealed case, formed of a frame, a square rear panel and a square front panel assembly. The frame and the rear panel are fabricated of a corrosion resistant material, such as stainless steel. The front panel assembly is comprised first of a transparent material, such as an acrylic polymer. Under the transparent front panel is a non-transparent graphics panel. On the graphics panel some warning indicia are applied. Proximate to the edges of the graphics panel is a border formed by an electroluminescent tape, which is inexpensive and easier to apply than electroluminescent paint, especially on custom-made or low production volume signs. The electroluminescent tape forms a rectilinear border around the indicia and is disposed parallel to the sides of the frame. The electroluminescent tape has two wire leads connected to an alternating current source which illuminates the tape. These leads protrude through the graphics panel and connected to an electrical power control located within the interior the marine warning sign. The transparent panel and the graphics panel are engaged with the front edges of the frame by a tight, waterproof seal.

Within the marine warning sign is an electrical power control, to provide alternating current to the wire leads of the electroluminescent tape. Power is preferably supplied by rechargeable direct current batteries. The batteries may be recharged from a solar cell or from some other external source of electrical power. A photoresistor engages the power to the electroluminescent tape at night. A flasher circuit may also provide in the power supply circuit to cause the electroluminescent tape border to flash, thereby increasing its visibility to other watercraft. The electrical power control includes one or two mercury level switches, to disengage power if the sign is overturned.

These and other objectives and advantages of the invention will become apparent from the description which follows. In the description, reference is made to the accompanying drawings, which from a part hereof, and in which is shown by way of illustration specific embodiments in which the invention may be protected. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### DESCRIPTION OF THE DRAWINGS

FIG. 1 is a perspective view of the invention.

FIG. 2 is a vertical sectional view of the invention.

FIG. 3 is an electrical circuit diagram of the control system of the invention.

FIG. 4 is an illustration of the corner of the electroluminescent tape border on the invention.

### DETAILED DESCRIPTION OF THE PREFERRED EMBODIMENTS

The following discussion describes in detail one or more embodiments of the invention. The discussion should not be construed, however, as limiting the invention to those particular embodiments, and practitioners skilled in the art will recognize numerous other embodiments as well. The complete scope of the invention is defined in the claims appended hereto.

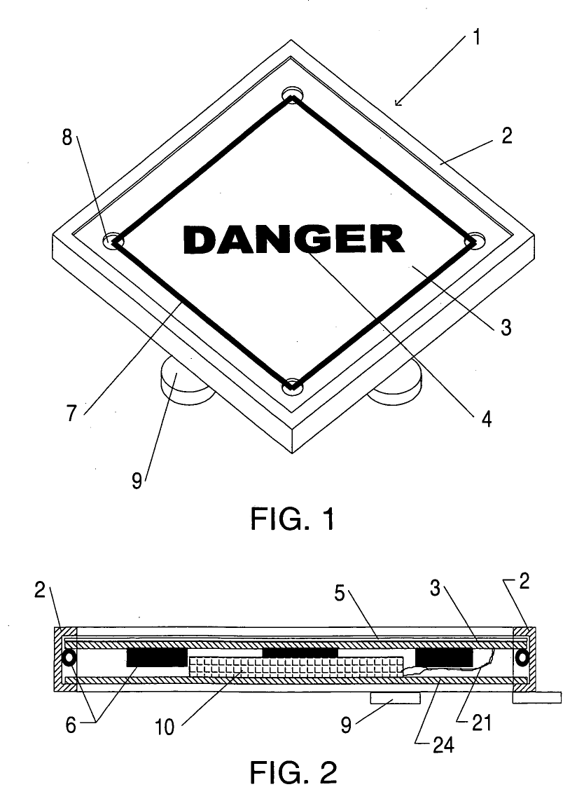

As shown in FIG. 1, the exterior of a marine warning sign 1 is in the form of a right prism, i.e., a shape in which the front and rear faces are square and are parallel and aligned to one another. The sides of the marine warning sign 1 are formed by a frame 2, comprised of four rectangular side panels, each panel having parallel lateral edges forming one edge of the front and rear faces, and parallel longitudinal edges, each of which are conjoined with a longitudinal edge of an adjacent side panel. In the preferred embodiment, the side panels of the frame 2 are mitered at 45 degree angles and conjoined to one another using angle brackets (not shown). When assembled, the side panels define a frame 2 with solid sides and open front and rear faces. In other embodiments, the front and rear faces may be in the shape of other polygons, and the number of rectangular side panels comprising the frame 2 equaling the number of sides of the polygon.

As shown in FIG. 2, a rear panel 24 encloses the rear face of the frame 2. In the preferred embodiment, the rear lateral edge of each side of the frame 2 has an orthogonal lip to which an edge of the rear panel 24 is attached flush with screws, rivets or other appropriate fasteners. A gasket or sealant may be used to provide a watertight seal between the edges of the rear panel and the side panels. A removable subpanel (not shown) is provided in the rear panel 24 for accessing the internal space of the sign, where an electrical power control 10 and ancillary circuits, as described below, are installed.

An assembly comprised of a transparent panel 5 and a graphics panel 3 is disposed within the front face of the frame 2. The two panels are held in place behind a medical flange or lip on the front edge of the frame 2 by fasteners or clamps 6. In the preferred embodiment, the clamps 6 are comprised of a short section of thick-walled elastomeric tubing. These clamps 6 are adhered to the interior wall of the frame 2 at a position which leaves a gap between the clamp 6 and the flange on the front edge of the frame 2 sufficient to engage the assembly of the transparent panel 5 and the graphics panel 3. A gasket or sealant may be applied between the obverse face of the transparent panel and the interior surface of the flange to provide a water-resistant seal. The transparent panel 5 is made of a tough, transparent material, such polycarbonate or polyacrylic plastics, or of glass. The graphics panel 3 may be fabricated of a material suitable as a substrate for printing or applying indicia 4, including cardboard or, preferably, high density polypropylene or high density polyethylene sheets.

In the most preferred embodiment, the marine warning sign 1 is in the shape of a cubic prism, with four sides and square rear and front faces. The rear panel 24 and front panel assembly will necessarily also be square. This embodiment will, when in use, typically be orientated with one angle or corner of the square face directed vertically, as a diamond. In this orientation, the indicia 4 on the graphics will be applied either horizontally or vertically along a long diagonal of the graphics panel 3.

After the indicia 4, as desired, is applied to the graphics panel 3, an illuminative border is applied to the graphics panel 3. The illuminative border forms the same polygonal shape of the front face of the frame 2, and is parallel to and inset from the edges of the graphics panel. In the preferred embodiment, the illuminative border is made by the application of electroluminescent tape 7. Electroluminescent tape 7 is preferred because it provides sufficient illumination with minimal power requirements, and a tape format can be applied more quickly and securely. However, since the obverse surface of the graphics panel 3 is against the reverse surface of the transparent panel 5, the applied electroluminescent tape 7 cannot protrude significantly beyond the obverse surface of the graphics panel 3. Electroluminescent tape 7 is generally stiff and inflexible, at least across its width, and therefore cannot simply be bent or stretched to form an angle or corner coplanar with the surface of the tape.

An angular corner in the electroluminescent tape 7 is created, as shown in FIG. 4, by placing a hole 8 in the graphics panel 3 at the location of each corner of the border and inserting a short length of the electroluminescent tape 7 through the hole 8. The short section of tape which was inserted is formed into a loop 23 on the reverse side of the graphics panel 3, permitting the next section of the length of electroluminescent tape 7 to be directed in another direction flush on the obverse face of the graphics panel 3 without creating any protrusions above the obverse face of the graphics panel 3 which may interfere with contact with the reverse face of the transparent panel 5. This technique of passing the electroluminescent tape 7 through a hole 8 and forming a loop 23 on the reverse side of the graphics panel 3 is repeated at all corners of the border created by the electroluminescent tape 7. At the last corner, the terminal end of the electroluminescent tape 7 is passed through the hole 8 into the interior of the marine warning sign 1, where an electrical power control 10 is connected by wire leads 21 on the terminal end of the electroluminescent tape 7.

An electrical power control 10 provides alternating electrical current, which is necessary for illuminating electroluminescent tape 7, to the two wire leads 21 on the end of the electroluminescent tape 7 within the interior of the marine warning sign 1. Electrical power is initially provided by one or more batteries 11. Preferably, the batteries 11 are rechargeable from an external source of direct current electrical energy. A pair of connectors 22 wired to the two poles of the battery provides the means for electrically connecting an external power source for recharging the batteries 11.

In the preferred embodiment, the circuit from the positive pole of the battery 11 is first connected to a rectifier diode 12, and then one or more mercury switches in series 13. The mercury switches 13 are installed in the interior of the sign so that they are horizontally level in two planes when the faces and sides of the marine warning sign 1 are plumb. Preferably, two mercury switches 13 are provided for assuring horizontal level in both axes. The circuit then continues to the collector junction of a PNP transistor 16, preferably a Darlington type, Model NTE2342. The transistor 16 provides the means for switching current to the dc-ac inverter 20 during low ambient lighting intensities. The base of the transistor 16 is connected by a circuit to the output of an op amp comparator integrated circuit (“IC”) chip 17 (“comparator”), preferably an NTE941M. The comparator 17 compares the voltage applied to two of its inputs 18, 19. Each input 18, 19 is connected to a bridge across the negative and positive circuits of the battery supply. One input 18 is connected to a one bridge circuit having one photoresistor 15, which is physically mounted on the exterior of the marine warning sign 1, and a fixed resistor 14. The other input 19 is connected to a bridge circuit with two fixed resistors 14. The resistors 14 in the two bridges are balanced so that, in daylight, the resistance caused by the photoresistor 15 results in an equal voltage at the inputs 18, 19 from the two bridge circuits. Thus, the voltages at the two inputs of the comparator are equal, and the output of the comparator is switched off. When the comparator 17 is switch off, the transistor 16 is reversed biased, and no current flows through it, effectively switching off the ac-dc inverter 20.

When ambient light intensity decreases after sunset, the resistance of the photoresistor 15 changes, causing a change between the measured voltages at the two inputs 18, 19 of the comparator 17. This causes the output of the comparator 17 to switch on, thereby forward-biasing the transistor 16, and allowing current through its collector, thus completing the circuit from one pole of the batteries 11 to the inverter 20 and back to the other pole of the batteries 11, thereby energizing the inverter 20. The inverter 20 then provides alternating current across the two wire leads 21 of the electroluminescent tape 7, thereby causing the tape 7 to illuminate.

The preferred embodiment of the electrical power control includes one or more mercury switches 13. These mercury switches 13 are installed so as to be orientated horizontally when the marine warning sign 1 is installed in its desired attitude. When the marine warning sign 1 is properly installed in the intended attitude, the mercury switches 13 will close and the electrical power control is enabled. If the marine warning sign 1 is tilted from its intended attitude, one or more of the mercury switches 13 will open, thereby disabling the electrical power control 10. In the preferred embodiment, two mercury switches 13 are used, positioned level and orthogonally to each other, to disable the electrical power control 10 in the event of rotation of the marine warning sign 1 in either the longitudinal or saggital planes.

A flasher circuit (not shown), the design of which is well known in the art, may be included in the power supply circuit to cause intermittent flashing of the electroluminescent tape 7 border.

To provide for portability and versatility of the marine warning sign 1, it is preferably mounted to a steel ship's hull or structure using magnets 9. One or more magnetic feet 9 are positioned to the rear of the frame 2 of the marine warning sign 1. The magnets 9 are positioned to align the sign with its indicia 4 in the desired orientation when the sign is mounted on either a horizontal or a vertical surface.

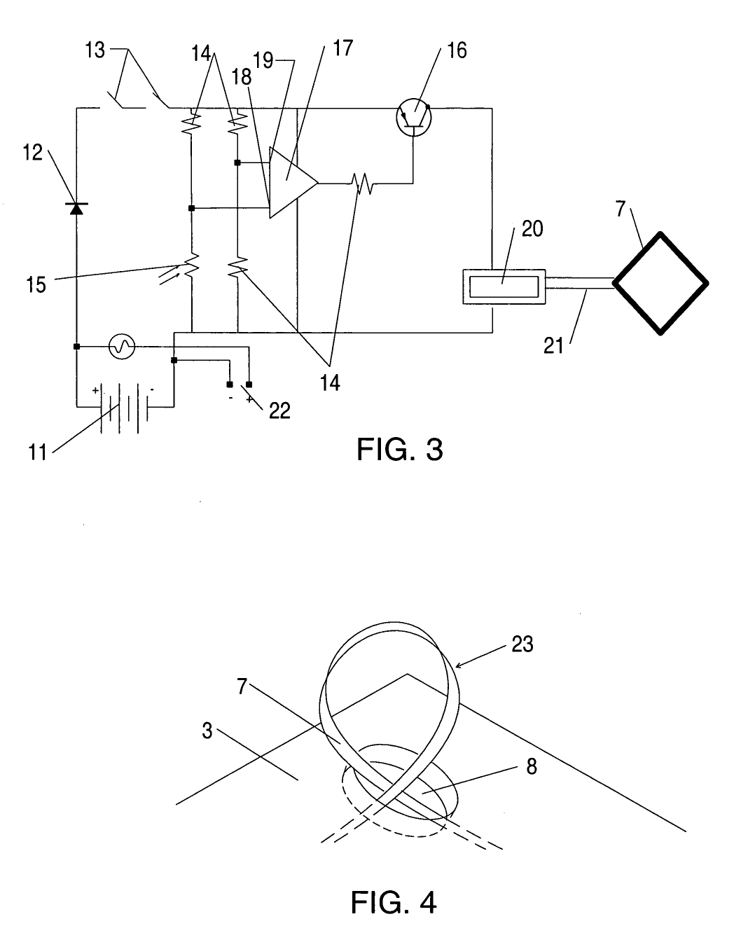

A removable panel (not shown) is provided in the rear panel 24 of the sign 1, for accessing the electrical and electronic components for repair and for replacing the batteries once they have permanently discharged. A receptacle 22, shown in FIG. 3, is provided in the rear panel 24 for providing a connection for an electrical supply for recharging the batteries in the power supply.

While various embodiments of the invention have been described above, it should be understood that they have been presented by way of example, and not limitation. It will be apparent to person skilled in the relevant art that various changes in form and detail may be made therein without departing from the spirit, and scope and application of the invention. This is especially true in light of technology and terms within the relevant art that may be later developed. Thus, the present invention should not be limited by any of the above-described exemplary embodiments, but should only be defined in accordance with the appended claims and their equivalents.

We claim:

1) A marine warning sign, comprised of:
a) A frame, having open front and rear faces and solid sides, in the form of a right polygonal prism;
b) A back panel; disposed at the rear face of the frame;
c) A graphics panel, having obverse and reverse surfaces and disposed in the front face of the frame, wherein a desired indicia is disposed on the obverse surface of said graphics panel;
d) A border on said graphics panel, said border comprised of electroluminescent tape disposed on the obverse surface of the graphics panel, said electroluminescent tape outlining a polygon around said indicia; and
e) An electrical power control which provides electrical energy to the electroluminescent tape.

2) The marine warning sign of claim 1, wherein the shape of the front and rear faces is a square.

3) The marine warning sign of claim 1, further comprising holes in the graphics panel disposed at each of the corners of the polygon border formed by the electroluminescent tape, wherein each corner of the border is formed by a section of the electroluminescent tape passed through each hole and formed into a loop on the reverse side of the graphics panel.

4) The marine warning sign of claim 1, wherein the power supply is comprised of an inverter providing alternating electrical current to the electroluminescent tape from a source of direct electrical current.

5) The marine warning sign of claim 3, wherein the source of direct electrical current is one or more batteries.

6) The marine warning sign of claim 1, wherein the power supply is further comprised of one or two switches for deactivating power to the electroluminescent tape when the marine warning sign is not orientated in a predetermined attitude.

7) The marine warning sign of claim 6, wherein the switches are mercury level switches.

8) The marine warning sign of claim 3, wherein the power supply is further comprised of an enabling means for enabling electrical power supply to the inverter only during conditions of low ambient light.

9) The marine warning sign of claim 8, wherein the enabling means is comprised of a photoresistor.

10) The marine warning sign of claim 9, further comprising a comparator circuit utilizing the voltage drop across the photoresistor for energizing the electrical power supply to the inverter.

11) The marine warning sign of claim 10, wherein the means for enabling electrical power supply to the inverter is energized by the comparator circuit utilizing a transistor.

12) The marine warning sign of claim 1, further comprised of magnetic mounts for mounting the marine warning sign to a metal surface.

13) The marine warning sign of claim 1, further comprising a transparent panel disposed in the front face of the frame conjoining with the obverse face of the graphics panel.

14) A method for forming an angular bend in a tape applied flush to a substrate, wherein said substrate is comprised of an obverse and a reverse surface, said method comprised of:
a) Providing a hole through the substrate at the desired location of the bend;
b) Passing a section of the tape through the hole from the obverse side of the substrate;
c) leaving a first and second end sections of the tape remaining on the obverse side of the substrate;
d) Forming a loop in the section of tape on the reverse side of the substrate; and
e) Securing the first and section end sections flush on the obverse surface of the substrate at an angle to each other.
